(19) United States
(12) Patent Application Publication
(10) Pub. No.: US 2010/0299899 A1
(43) Pub. Date: Dec. 2, 2010

(54) METHOD OF CONVERTING EXISTING STATIC SIGN TO A DIGITAL SIGN

(76) Inventor: James H. Johnson, JR., Lexington, KY (US)

Correspondence Address: KING & SCHICKLI, PLLC, 247 NORTH BROADWAY, LEXINGTON, KY, 40507, US

(21) Appl. No.: 12/790,131

(22) Filed: May 28, 2010

Related U.S. Application Data
(60) Provisional application No. 61/182,453, filed on May 29, 2009.

(51) Int. Cl. B23P 17/04

(52) U.S. Cl. 29/401.1

(57) ABSTRACT

A method is provided for converting an existing static sign to an outdoor advertising, storage and information structure. The method includes the steps of adding a storage structure to an existing sign and adding a real time digital message board or electronic display device to the existing sign structure.

This application claims the benefit of U.S. Provisional Patent application Ser. No. 61/182,453 filed on 29 May 2009, the full disclosure of which is incorporated herein by reference.

### TECHNICAL FIELD

The present invention relates generally to the disaster preparedness and disaster response fields.

### BACKGROUND OF THE INVENTION

Various government agencies including but not limited to Homeland Security, Emergency Management, Law Enforcement, Fire, EMS, Health Department and Environmental Protection Agencies are under popular mandate to alert and inform the public of and rapidly respond to both man made and natural disasters. In order to achieve these ends, these government agencies must be able to immediately access and use a broad based communications network capable of informing as large a segment of the population as possible respecting potential or actual disasters. In addition, the agencies must have emergency response equipment and relief supplies at hand and available for use on a 24/7 basis. In fact, sufficient quantities of relief supplies should be at hand for the first critical 24 to 48 hours following a disaster so that the public will not be forced to do without critical goods such as drinking water, food and medicine until they can be shipped in from a remote location.

Currently, many advertising companies and business operators own static signs and billboards that they would like to convert to digital technology. However, local sign ordinances often limit or prevent this conversion.

The present invention relates to a method by which advertising companies and business operators secure the right to convert their existing signage to digital message boards while simultaneously enhancing the disaster preparedness of a community.

### BRIEF DESCRIPTION OF THE DRAWINGS

The accompanying drawing incorporated herein and forming a part of the specification, illustrates several aspects of the present invention and together with the description serve to explain certain principles of the invention. In the drawings:

FIG. 1 is a schematical front elevational view illustrating a state of the art monopole billboard; and

FIG. 2 is a schematical front elevational view illustrating a monopole billboard modified to include a storage structure for holding equipment or provisions for responding to emergency situations and a real time message board or electronic display device.

Reference will now be made in detail to the present preferred embodiment of the invention, an example of which is illustrated in the accompanying drawing.

### DETAILED DESCRIPTION OF THE PREFERRED EMBODIMENTS OF THE INVENTION

The present invention relates to a method for converting an existing sign such as a static billboard B to an outdoor advertising, storage and information structure.

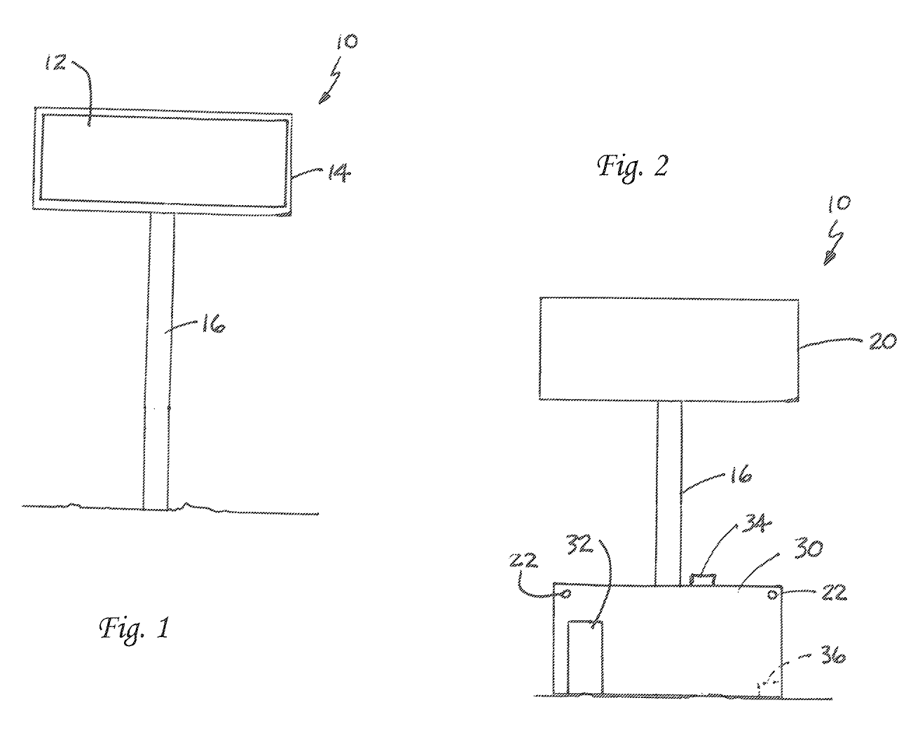

As illustrated in FIG. 1, the existing sign 10 comprises a static billboard advertisement that may be formed, for example, by adhering a printed vinyl sheet 12 to a supporting sign panel 14. As illustrated, the panel 14 is supported by a monopole support or post 16.

In accordance with the present invention as illustrated in FIG. 2, the static advertisement and panel 14 are replaced with a digital message board 20. Digital message boards may take any appropriate form including but not limited to an LED display. In addition, a storage structure 30 with an access door 32 is built in or around the sign 10. In the illustrated embodiment, the storage structure is built around and connected to the monopole 16. In addition, the storage structure 30 may be anchored to the ground.

Preferably the storage structure is constructed from modular building panels such as pre-fabricated panels of the type shown and described in, for example, U.S. Pat. No. 6,279,287 to Meadows, U.S. Pat. No. 5,373,678 to Hesser and U.S. Pat. No. 6,119,427 to Weiman et al. Such panels typically incorporate a core of thermal insulating material sandwiched between metal or plastic sheeting. Such a construction allows one to efficiently and effectively control the temperature and humidity of the environment within the internal space of the storage structure 30 and allows for excellent inclement weather durability for a long, low-maintenance service life. Structures 30 constructed from such modular building panels are also characterized by high strength and will resist high winds and maintain a weather-tight enclosure to protect the products held in the space from inclement weather. As a consequence the structures are ideal to store emergency relief supplies or provisions as well as other emergency equipment. The modular panels also allow the structure to be quickly and easily erected in a minimal amount of time while producing a minimum mess.

For purposes of this invention, emergency relief supplies are to be broadly interpreted. Relief supplies include but are not limited to, drinking water, food, diapers, blankets, bedding, tents, clothing, medicines, first aid kits and the like. For purposes of this invention emergency equipment is also to be broadly interpreted but includes but is in no way limited to hand tools, first aid kits, hazardous material suits, contamination suits, communications equipment such as walkie-talkies, satellite telephones and the like, electric generators, batteries, chainsaws and other useful power tools.

The structure 30 may be equipped with various electrical and/or mechanical systems. For example, air conditioning, refrigeration or other temperature control units 34 may be provided on the structure 30 in order to provide climate control of a portion or all of the internal space within the structure. This allows staple products such as drinking water and food to be stored at desired temperatures even in hot and humid environments. Advantageously this increases the shelf life of disaster relief supplies and ensures that those supplies may be effectively made available to the community on a permanent basis 24 hours a day, 7 days a week.

The digital message board or electronic display device 20 may take substantially any appropriate form including but not limited to a liquid crystal display, a plasma monitor or an LED display. The device may also include one or more speakers 22 for the presentation of audio. Thus, audio/video emergency messaging is possible. Still further, the structure 30 may incorporate a radio transmitter 36 for the transmission of audio such as low wattage transmission on 89.1 FM where noise concerns or ordinances at the particular site prevent the presentation of an audio feed to a speaker.

Besides advertising, public service messages and emergency alerts and warnings may be broadcast over the digital message board 20 and the speaker system 22 if desired. Thus, important messages such as Amber Alerts may be broadcast to the community. Similarly, in the event of a natural or man made disaster, emergency messages may be broadcast. These can take any form including, for example, directions to emergency shelters or other sources of emergency supplies.

In accordance with the present method broadcasting includes the feeding of selected video (and/or attendant audio) to the video message board 20. In this regard, the digital message board 20 is connected to a real time communications network such as described in co-pending patent application Ser. No. 12/051,427.

In summary, numerous benefits result from employing the present method. First and foremost, the disaster preparedness of any community is significantly enhanced by the addition of an emergency message board with real time messaging capability and the provision of emergency relief supplies that are permanently available on site and are available to relieve the community 24 hours a day, 7 days a week. Since the provisions are already in place before a disaster, they are available during the first critical 24 to 48 hours following a disaster. This means that a community will not have to do without critical provisions during the time relief efforts are mobilized and supplies are being brought to the community from remote locations.

Second, the advertising company or business operator that owns the sign benefits. More specifically, by providing local government agencies with communication and storage to enhance local disaster preparedness, the advertising company or business operator who owns the existing sign gains government approval to convert that sign to a digital message board. This allows the company or operator to present digital advertising which can be more influential in reaching a potential customer.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A method for converting an existing static sign to an outdoor advertising, storage and information structure, comprising:
adding a storage structure to said existing sign;
adding a real time digital message board or electronic display device to said existing sign.

2. The method of claim 1, including storing relief supplies in said storage structure.

3. The method of claim 2, including controlling temperature inside said storage structure.

4. The method of claim 1, including equipping said sign for radio transmission.

5. The method of claim 1, including equipping said sign for audio messaging.

6. The method of claim 1, including storing drinking water in said structure.

7. The method of claim 1, wherein said existing sign is a monopole billboard, said method further including attaching said storage structure to said monopole.

8. The method of claim 1, including anchoring said storage structure to the ground.

9. The method of claim 1, including equipping said sign with an electrical generator.

10. The method of claim 1, including equipping said sign with two-way communications equipment.

11. A method of gaining government approval for converting an existing static sign to a digital sign, comprising:
adding a storage structure to said sign; and
allowing a government entity to use storage space in said storage structure to store government supplies and/or equipment.

12. The method of claim 11 including adding a real time message board or video display device to said sign and allowing a government entity to display a desired message on said message board or display device.
